(19) United States
(12) Patent Application Publication
(10) Pub. No.: US 2021/0311458 A1
(43) Pub. Date: Oct. 7, 2021

(54) COMMUNICATION DEVICE AND METHOD OF TRANSFERRING DATA FROM A CONTROL LOOP

(71) Applicant: SICK AG, Waldkirch (DE)

(72) Inventors: Bernd APPEL, Waldkirch (DE); Marc LANIGRA, Waldkirch (DE); Bahram TORABI, Waldkirch (DE)

(21) Appl. No.: 17/219,404

(22) Filed: Mar. 31, 2021

(30) Foreign Application Priority Data
Apr. 2, 2020 (DE) 10 2020 109 241.5

(51) Int. Cl. G05B 19/414; G05B 19/4062; G05B 19/25

(52) U.S. Cl. CPC G05B 19/414; G05B 19/256; G05B 19/4062

(57) ABSTRACT

A communication device for a control loop is provided having a control device and an actuator that is connected to the control device via a connection line and that has a sensor for determining a control variable. In this respect, the communication device has a first interface for connecting to the control line for a connection to the control device, a second interface for a connection to the actuator, and a third interface for a connection to a third system to transfer at least some of a communication on the connection line or data acquired therefrom to the third system.

The invention relates to a communication device for a control loop and to a method of transferring data from a control loop.

Such a control loop is implemented in a servo motor, for example. A servo motor regulates the angular position of its motor shaft or the (angular) speed and acceleration. It is necessary for this purpose to measure the respective rotational position or angular position and encoders or rotary encoders used therefor are also called motor feedback systems. The regulating electronics, that are sometimes called a servo drive and in the following also a servo controller, is typically accommodated displaced outside the actual motor. Communication must accordingly be established in the control loop between the motor or its rotary encoder and the servo controller. The motor is additionally naturally also supplied with the respective currents of the correct phase for its operation. Since the control loop has to be able to react very quickly, there are real time demands on the communication and the control loop is therefore also called as fast (feedback) loop.

A purely digital motor feedback protocol for this communication that manages with a minimum of connection lines is the open interface HIPERFACE DSL® of the applicant. A corresponding control loop for a motor 100 is shown in FIG. 8. The respective angular position of the motor shaft 102 is determined via an encoder or rotary encoder 104 marked as MFB—for motor feedback. A servo controller 106 is connected via a cable 108 to the motor 100 and the rotary encoder 104. The cable 108 has a respective part line 110, 112 for the control and supply of the motor 100 or for the transfer of the angular position from the rotary encoder 104. The servo controller 106 Is aware of the control variable, that is the current angular position, in this manner and can control it by a corresponding control of the motor in accordance with its command variable. Further details on the interface can be found at www.hiperfacedsl.com

Communication in the control loop is, however, closed in itself so that there is no simple possibility of diagnosis, improvement, or other data analysis. Any intervention in the control loop not directed to the actual control function is also conventionally shied away from due to the real time demands in the fast loop. However, this all makes the integration in modern infrastructure more difficult, for instance in applications of Industry 4.0.

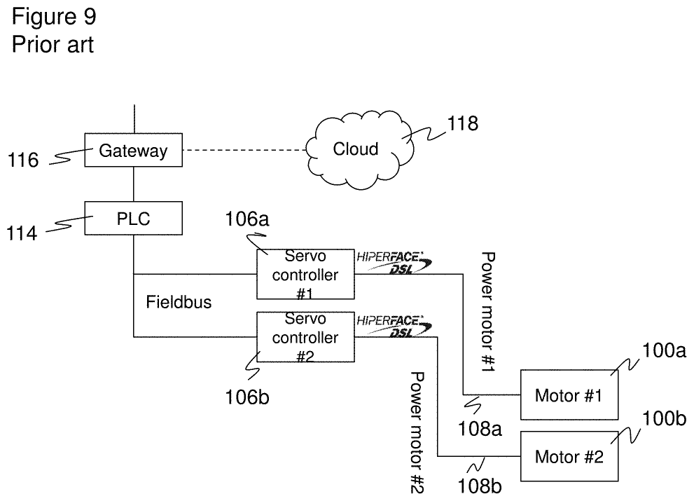

FIG. 9 shows a conventional approach to nevertheless make the data from the control loop accessible. In the example shown, two control loops are provided each having a motor 100a-b, a servo controller 106a-b, and a connection line 108a-b in accordance with HIPERFACE DSL®, with this number varying in dependence on the application. The servo controllers 106a-b are connected via a common control protocol such as fieldbus to a system control 114 represented by a programmable control PLC.

The data from the communication in the control loop is in principle available in the system control 114, but only to the extent that the system control 114 requires and therefore reads them and can transfer them. A gateway 116 can access the data provided in this manner and can transfer them into any desired data processing system that is here represented by a cloud 118. The disadvantage is that the available data are thus restricted by the system control 114 and an interface for the gateway 116 to the system control additionally has to be provided. A respective individual solution is thus necessary that is prepared with the operator of the system control 114. This is an extremely inflexible and complex way to obtain a still incomplete insight into the control loop and the data of the motor feedback system in an indirect manner. It is therefore the object of the invention to enable an improved data acquisition via a control loop.

This object is satisfied by a communication device for a control loop and by a method of transferring data from a control loop in accordance with the respective independent claim. The control loop comprises a control device and an actuator that determines a control variable using a sensor, for example an encoder device. The encoder device is here preferably to be understood so broadly that the actuator can report the control variable back in any desired manner. The control loop is preferably real time enabled and at least configured for very narrow and fast feedback (fast loop). The respective acquired control variable or the controls required for the subsequent control are communicated over a connection line between the control device and the actuator. The connection line therefore makes bidirectional communication possible.

The invention starts from the basic idea of hooking the communication device into the connection line of the control loop. A first interface for the connection to the control device and a second interface for the connection to the actuator are provided for this purpose. The connection between the control device and the actuator accordingly takes place by the communication device that divides the previous connection line into two halves, with the previous communication being simply passed through or only being modified in an exactly defined manner without interfering with the control in dependence on the embodiment. A third interface connects the communication device to a third system outside the control loop. At least some of the communication between the control device and the actuator or its sensor or encoder device are outwardly transmitted to the third system over this connection. The third interface can in principle be a memory card that is read later, but is preferably a data interface that is read online or at least almost in real time by the third system, with a buffer memory for a time offset reading preferably still remaining conceivable.

The invention has the advantage that the data from the control loop or those of the sensor or of the encoder device are available in the third system in a flexible manner. Complex data evaluations, diagnoses, and improvements within the framework of modern data infrastructure are thus made possible within the framework of Industry 4.0. Unlike the conventional solution via a system control presented with reference to FIG. 9, the invention remains independent of the manufacturer of the control loop and of the total system together with its system control. It only has to be agreed with the respective system operator which data should be read and how their evaluation should possibly have a subsequent effect on the system. The hardware and software for the data transfer is, however, a universal solution that does not have to be adapted according to the control loop, the system control and the specific fieldbus interface, and the like. The robust communication between the control device and the actuator remains unimpaired and will at most be further improved in that, for example, safety functions are added.

The actuator is preferably a motor, the sensor a rotary encoder or motor feedback system, and the control device a servo controller. The control loop is thus that of a servo motor as already presented in the introduction. This is an important and frequent application, with the systems, however, very frequently differing in details so that the flexibility of the invention particularly comes to the fore. There are additionally very hard real time demands in a servo motor so that an intervention in the control loop by conventional means is not considered.

The third interface is preferably a wired or wireless interface for data communication in accordance with a standardized data communication protocol, in particular a network protocol. The communication device can act as a translator from the protocol on the connection line into any desired protocol for the third system. A gate from the special communication within the control loop is thus provided in all commercial or otherwise desired communication worlds, both as regards the physical link and the data protocols. The connection between the third interface and the third system therefore takes place, for example, over Ethernet, G5, UMTS, WiFi or Bluetooth and by means of TCP/IP or UDP or other systems.

The third system is preferably a computer for analyzing a system with the actuator, a network of the system, or a cloud. Depending on the embodiment, a dedicated computer is provided that processes the data from the third interface, a connection in an existing network of the system or in a higher ranking system such as a cloud is provided.

The control device and the actuator preferably communicate over the connection line in accordance with the standard HIPERFACE DSL® or IO-Link. The standard HIPERFACE DSL® was explained in the introduction and enables very robust real time communication in the control loop so that a corresponding design of the communication device is particularly advantageous. There are, however, also other established interfaces with which a sensor or an encoder device can communicate, which includes IO-Link.

The first and/or second interfaces are preferably formed in accordance with the standard HIPERFACE DSL® or IO-Link. Depending on the embodiment of the communication device, this is restricted to the physical design to be able to connect the connection line at all or it signifies fully-fledged interfaces.

The connection line is preferably continued in the communication device between the first interface and the second interface and allows signals of the connection line to pass, in particular while amplifying the signals. The communication device in this embodiment behaves passively with respect to the communication within the control loop. The corresponding signals are only looped through. Simple changes, for instance an amplification and thus a kind of repeater function and the like are conceivable here. The communication device moreover taps the communication signals and transfers them like a splitter in an unmodified manner or after processing over the third interface.

The communication device preferably has a master/slave unit connected to the first interface and to the second interface. In this embodiment, the connection line of the control loop is practically cut up and divided into two communication circuits. The communication device is involved in both communication circuits to the actuator and to the control device. The function can nevertheless be restricted to simply transfer the respective content so that it is admittedly not looped through physically, but ultimately likewise only looped through in content. It is, however, now also possible to intervene in the communication of the control loop. The master/slave unit is preferably configured in accordance with the standard HIPERFACE DSL® or IO-Link; the first and second interfaces are then configured accordingly.

The communication device preferably has a communication control that is configured to evaluate the signals transmitted between the actuator and the control device on the connection line and to decide which signals and/or data are output at the first interface, at the second interface, and/or at the third interface. The communication device thus becomes an intelligent communication participant in the control loop. However, how this function is actually used differs in dependence on the embodiment. All the data can be simply transferred, specific data can be filtered, modified, or even artificial data can be channeled in. The communication over the first or second interface can do this itself in the control loop, for instance to ensure its safety or to increase a safety level, just as an intelligent selection or pre-processing can relate to the communication to the third system, with data in particular being filtered, sorted, and/or pre-processed before they are externally output over the third interface. The communication control preferably only serves as an executing member; the third system that can be as powerful as desired is available for the actual intelligence of the data evaluation.

The communication control is preferably configured to compare the signals and/or data with an expectation. This enables an automatic analysis and diagnosis, for example a report, when the data appear unusual with respect to other operation times, systems of the same construction, and the like.

The communication control is preferably configured for a protocol adaptation, in particular a change of the resolution and/or data rate, between the first interface and the second interface. The communication device can thereby provide compatibility between the control device and the sensor or encoder device. This facilitates servicing, updating, and converting a control loop without a communication device into a control loop with the communication device in accordance with the invention. A different control device can, for example, be used in the control loop without replacing the sensor or the encoder device. Any additional protocol adaptation that may be required can take place simply by a firmware update instead of a replacement of hardware.

The communication control is preferably configured to at least partially replace the data flow of the actuator and/or the control device. A sensor or an encoder device is thus complemented on the one side, for example in that a pre-processing, an interpolation, or the like is carried out that is expected by the control device, but is not performed by the sensor. In an extreme case, the sensor is emulated in total in that the communication device wholly replaces its communication. In the reverse communication direction, the communication control can intervene in a regulating manner or can, for example, reconfigure the sensor.

The communication control is preferably configured to require additional data from the sensor that the communication link does not need. The sensor or the encoder device is possibly able to satisfy more functions than are required in the control loop. This could be an even higher measurement resolution or a further measured variable such as the temperature. Further examples include diagnosis data or log files of the sensor. The communication device can transfer such data additionally, that is functionally in parallel with the control loop, to the third system.

The communication device preferably has at least one connector for an additional sensor. It can be an additional sensor attached to the actuator or in its area of effect or a completely different additional sensor that supports the analysis of the data of the sensor in the control loop or of the control loop at all such as a temperature sensor.

In the method in accordance with the invention, a communication device, in particular a communication device in accordance with the invention in accordance with one of the described embodiments, is hooked into the control loop. The existing connection line is cut up, viewed functionally, for this purpose and the two halves are each connected between the first interface and the control device or between the second interface and the actuator. As a rule, two separate cables would naturally actually be used for this purpose.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

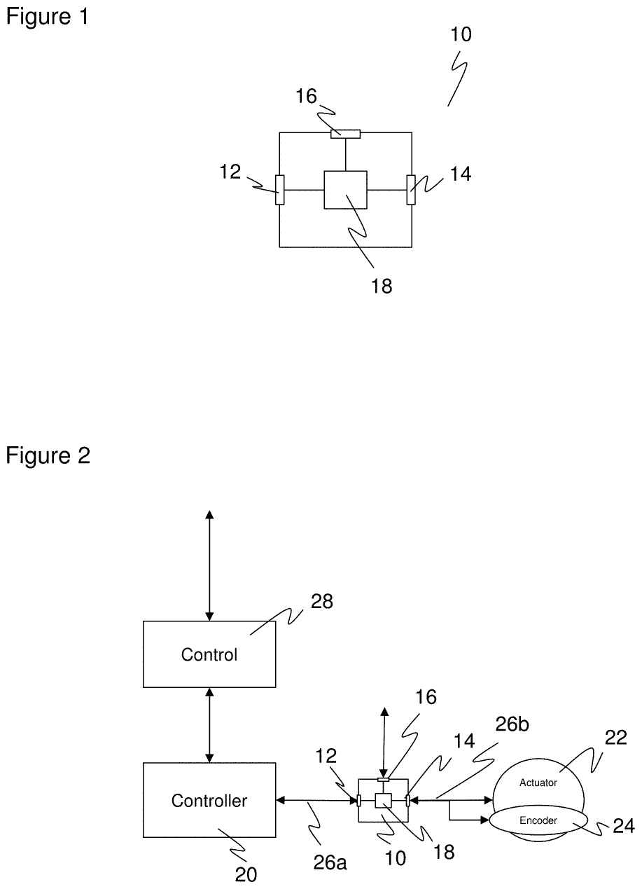

FIG. 1 a schematic representation of a communication device;

FIG. 2 a schematic representation of a communication device in the connection line of a control loop;

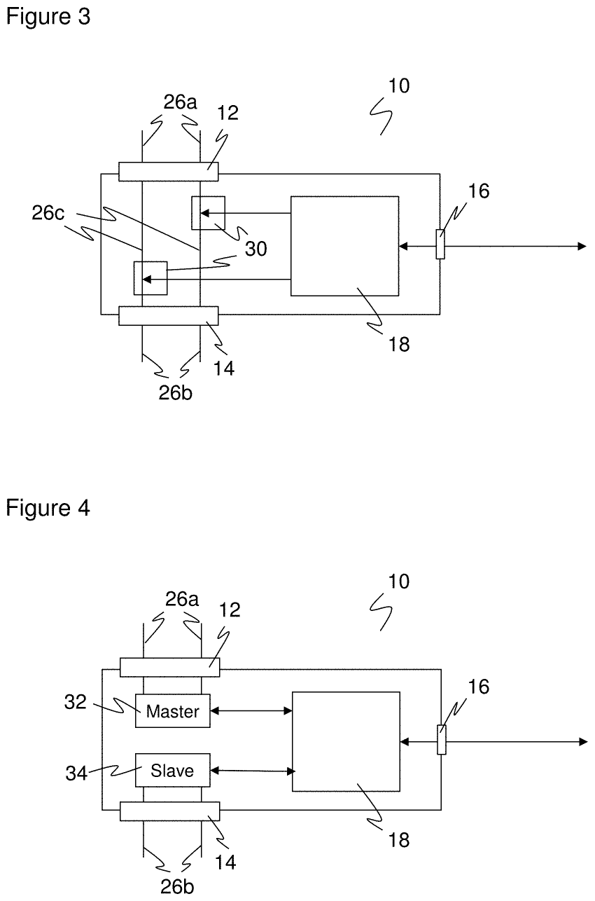

FIG. 3 a block diagram of a communication device in an embodiment as a splitter;

FIG. 4 a block diagram of a communication device in an embodiment with a master and a slave;

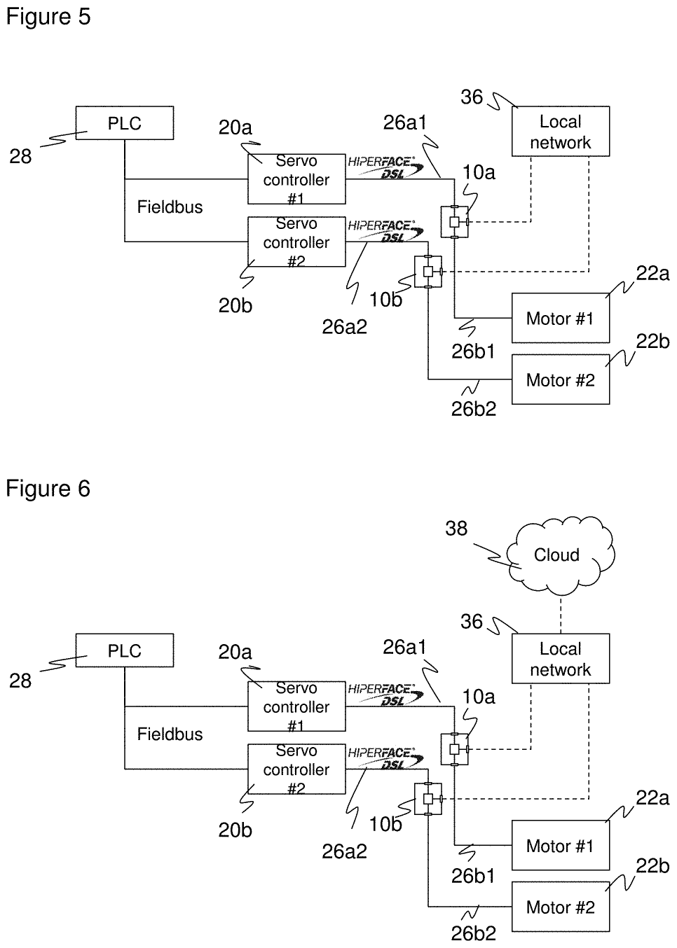

FIG. 5 a schematic representation of the arrangement of a communication device in the control loop of a servo motor for data transfer to a local network;

FIG. 6 a representation in accordance with FIG. 5, now with a data transfer to a cloud;

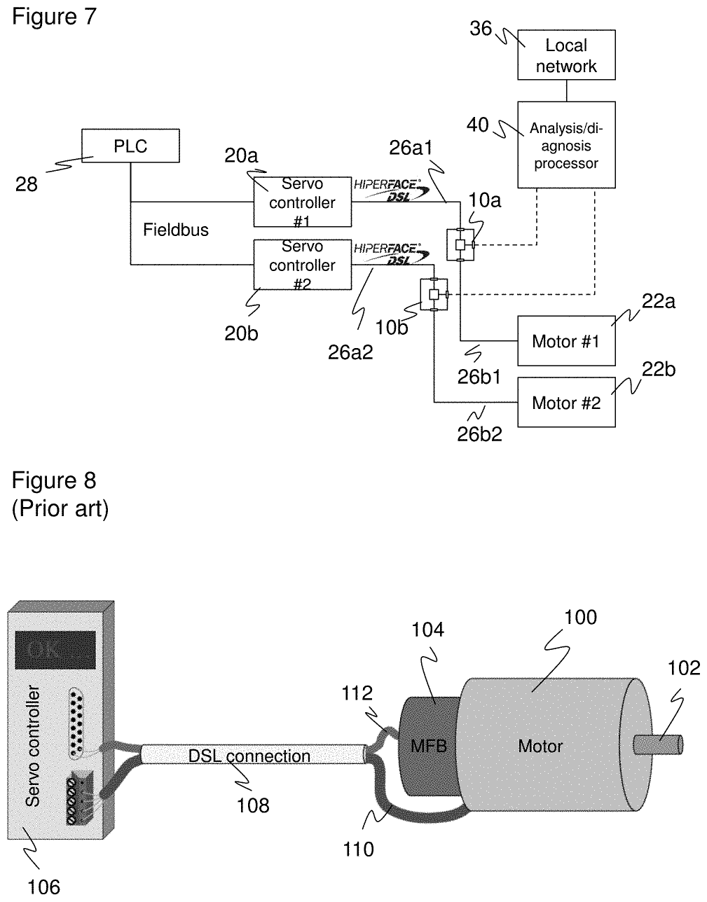

FIG. 7 a representation in accordance with FIG. 6, now with a data transfer to a dedicated analysis/diagnosis processor;

FIG. 8 a representation of a conventional control loop in a servo motor; and

FIG. 9 a schematic representation of the transfer of data from a system control in accordance with the prior art that is higher ranking than the control loop.

FIG. 1 shows a schematic representation of a communication device 10. It has a first interface 12 and a second interface 14 to be used thereby in a connection line of a control loop. The connection line is then internally continued in the communication device 10 between the first interface 12 and the second interface 14. A third system can be connected in a wireless or wired manner to a third interface 16 to transfer data from the connection line to the third system or conversely to transfer data from the third system over the first or second interface o the connection line, in particular processing results based on the data previously transferred from the control loop. A communication control 18 coordinates the respective data transfer and optionally also already performs pre-processing and the like.

FIG. 2 shows the communication device 10 installed in a control loop. A controller 20 in the control loop controls an actuator 22 in real time or at least in very short cycles. To acquire the control variable, an encoder 24 is provided at the actuator 22, with some actuators 22 also taking over its function. The communication of the respectively acquired control variable required for the control (fast loop communication) or the controls required for the subsequent regulation takes place via a connection line 26a-b that is split over sides of the actuator to also include the encoder 24. This division takes place, for example, by a corresponding association of the individual lines of a multi-core connection line 26a-b. The connection line 26a-b can moreover supply the actuator 22. The controller 20 is connected to a control 28 example via a fieldbus

The communication device 10 is connected to the controller 20 via the first interface 12 and to the actuator 22 via the second interface 14. The connection line 26a-b is divided into two sections in this manner. The communication device 10 establishes the connection internally between the two sections 26a-b. In addition, at least some of the communication with the encoder 24 or with the controller 20 or data led off thereon is output to a third system via the third interface 16.

FIG. 3 shows a further embodiment of the communication device 10. The connection line 26a-b is here practically only led through on an internal section 26c. The first and second interfaces 12, 14 can remain restricted to physical plugs or jacks for continuing the connection line 26a-b. The communication between the controller 20 and the actuator or the encoder 24 remains functionally unchanged. However, additional modifications are conceivable here such as signal amplification and the like. The two single lines shown stand by way of example for a plurality of connection strands, for instance for the two communication directions, and can in turn have a plurality of cores.

In this embodiment, the communication on the connection line 26a-c is practically only overheard by a signal splitter 30 in any desired technical design. The communication control 18 select that information that is to be transmitted via the third interface 16 outwardly to the third system. There are different possibilities here, from a transfer of raw data signals, to a translation of the data communicated on the connection line 26a-c into a different data protocol, up to a pre-processing or even an analysis and diagnosis of these data.

FIG. 4 shows a further embodiment of the communication device 10. Unlike FIG. 3, the first and second interfaces 12, 14 are here formed as complete interfaces with a master unit 32 or with a slave unit 34. The communication device 10 therefore in this case interrupts the communication and actively conducts it on the two sections of the connection line 26a-b. The first and second interfaces 12, 14 together with their master units and slave units 32, 34 are configured for that protocol that is also otherwise used without the communication device 10 in the control loop on the connection line 26a-b.

In this embodiment, the communication device 10 has full control over contents and protocols. It can thus not only work as a splitter, but also as a translator, or furthermore also provide additional functions. Communication contents can thus also be selectively changed, filtered, or passed on within the control loop on the connection line 26a-b. Information can thereby be directly blocked; information can also be transferred that the control loop does not originally transfer; a data rate or a resolution and the like can be adapted. In principle, the communication device 10 could also use completely different protocols on the part sections of the connection line 26a-b. There is preferably no intervention in the communication for the actual control function. If this nevertheless takes place, it should be ensured that the communication device 10 only influences the control in a manner provided in the system. Such an intervention is then absolutely justifiable, for example to subsequently provide functional safety in the control loop by test processes and the like.

FIG. 5 shows the arrangement of an embodiment of the communication device 10 in the control loop of a servo motor. The embodiment in accordance with FIG. 1 is here shown purely by way of example; other embodiments are equally conceivable. The general design within the control loop corresponds to FIG. 9 already explained in the introduction. Two control loops are shown here purely by way of example, with instead only one control loop being possible and conversely, the number also being able to be a great deal higher in dependence on the system. While one respective communication device 10a-b per control loop is provided in FIG. 5, it would also be conceivable to provide additional connectors having a plurality of first and second interfaces 12, 14 for a plurality of control loops in only one single communication device 10a-b, but here preferably only to provide one common third interface 16.

The actuators in the servo motors are in each case motors 22a-b and the controllers are the associated servo controllers 20a-b. A motor feedback system as a respective encoder 34 preferably belongs to the motors 22a-b. The control loop therebetween communicates on a connection line 26a1, 26a2, 26b1, 26b2 into which the respective communication device 10a-b is hooked. Every single control loop can preferably be designed such as has been explained with respect to FIG. 8 in the introduction. The protocol in the control loop is then preferably HIPERFACE DSL®.

The third interface 16 communicates in this embodiment with a local network 36 of the system operator. There is preferably consequently a direct or indirect connection, not shown, in the background between the control 28 of the system and the local network 36. The third interface 16 can be configured for any desired network protocol, for example TCP-IP or UDP, and all known wired and wireless connections such as Ethernet, 3G, 4G, 5G, WiFi, Bluetooth, and other open or proprietary standards are conceivable for this purpose.

The data that are transferred over the third interface 16 into the local network 36 can be processed there using any desired analysis and diagnosis software. The system operator, the manufacturer of the servo motor, or the manufacturer of the encoders 24 or of the communication device 10 or a third party can provide the corresponding software. It is conceivable to transfer processing results back to the communication device, in particular to change configurations there or also to intervene in the control loop.

FIG. 6 is a similar representation to FIG. 5, with here the local network 36 again further being connected to a cloud 38. The third interface 16 could alternatively be directly connected to the cloud 38. A processing of the data from the control loop can take place ever very much more simply and more flexibly from the cloud 38. No local installation of software is necessary or this effort can at least be reduced by support from the cloud 38. A substantially more powerful and always up-to-date processing is possible. In addition, data can be acquired and analyzed together over a cloud 38 across a system over a plurality of systems. Analyses can become more and more exact and better by such measures, whether they are related to the system or are fed from a plurality of data sources, and critical states can, for example, be pointed out reliably and in good time.

FIG. 7 is again a similar representation to FIG. 5. Here, the third interface 16 is connected to an analysis/diagnosis processor 40 that is then optionally further connected to the local network 36. An additional connection to a cloud 38 is also possible, but it is an advantage of the arrangement in accordance with FIG. 7 that this is not necessary when the analysis/diagnosis processor 40 provides sufficient memory and processing power. The analysis/diagnosis processor 40 is adapted to cooperate with communication devices 10a-b and with the encoders 24 used. The required software packages to evaluate the data from the third interface 16 can there already be pre-installed by the manufacturer of the communication devices 10a-b, of the encoders 24, and/or of the servo motors. Alternatively, this installation takes place on site or is modified there. The advantage is at least that the analysis/diagnosis processor 40 represents a unit separate from the local network 36 that can also be under a different responsibility. Different technicians are thereby responsible for the analysis/diagnosis processor 40 and the local network 36. The system operator therefore to this extent does not have to take care of the installation and maintenance himself, but also does not have to let any outsiders intervene in his local network 36.

In the previous explanation, it has only generally been addressed that data from a control loop, in particular from a motor feedback control loop of a servo motor, can be expelled and possibly also transferred back by means of the communication device 10. Finally, some application examples should now be listed.

The data can be used for the diagnosis of the respective control loop and thus ultimately of the system. In this respect, comparisons with data of a specification, data from different operating times, or on different systems can take place as to whether indications of malfunctions, irregularities, required maintenance, or impending future failures result. The analysis can have the actuator 22, the encoder 24, or the application or system as its object and the actuator 22 or encoder 24 are integrated therein. This includes, for example, expectations on the behavior of the actuator 22 under load or an analysis of the processed load. Particularly such diagnosis functions can profit when they are supported on large data volumes and also make use of methods of machine learning, in particular deep neuronal networks. It is conceivable that the communication device 10 requests data over the connection line 26a-b that the controller 20 itself does not need and that are thus separately provided for the communication device 10 and thus the third systems 36, 38, 40. An additional diagnosis interface to the actuator 22 and the encoder 24 is thus provided.

It is furthermore conceivable, in particular with an embodiment in accordance with FIG. 4, that the communication device 10 for the controller 20 emulates the actuator 22 and the encoder 24 or conversely the controller 20 for the actuator 22 and encoder 24. The respective end points of the connection line 26a-b cannot distinguish what the source of the communication is. The makes further diagnoses possible and simplifies the further development because, for example, the actuator 22 does not have to be operated at all for tests.

The communication device 10 can act as a translator between different protocols on the sections of the supply line 26a-b. In this respect, only parameters can be modified in that, for example, the communication interface communicates with higher resolution to the one side than to the other side. It is, however, also conceivable to use completely different protocols to the controller 20 on the one side and to the actuator 22 and encoder 24 on the other side, in particular also different protocol versions. The communication interface thus makes it simpler to obtain the compatibility in the control loop.

In a further development of the communication device 10, not shown, at least one connector for an additional sensor is provided. The additional sensor does not directly belong to the control loop, but can acquire relevant values for it such as a temperature. The data of the additional sensor are included in the data analysis and in the decision as to which data are modified how and where they are transferred to. Alternatively, the communication device 10 for such further sensors can also only serve as loggers to transfer sensor data to the outside for very independent purposes.

For commercial applicability, there are a variety of options, in addition to the pure hardware of the communication device 10, for the evaluation of the data having become available therewith. Layered payment models are also conceivable in which only specific parts of the data are transferred or specific functions such as a higher measurement resolution are only made accessible via release keys. The communication device 10 facilitates the data output from the control loop both for new installations and in the event of an upgrading of an existing system.

1. A communication device for a control loop, the communication device comprising:
a control device and an actuator that is connected to the control device via a connection line and
a sensor for determining a control variable,
wherein the communication device has a first interface for connecting to the control line for a connection to the control device, a second interface for a connection to the actuator, and a third interface for a connection to a third system to transfer at least some of a communication on the connection line or data acquired therefrom to the third system.

2. The communication device in accordance with claim 1,
wherein the actuator is a motor, the sensor is a rotary encoder, and the control device is a servo controller.

3. The communication device in accordance with claim 1,
wherein the third interface is a wired or wireless interface for data communication in accordance with a standardized data communication protocol.

4. The communication device in accordance with claim 3,
wherein the standardized data communication protocol is a network protocol.

5. The communication device in accordance with claim 1,
wherein the third system is a computer for the analysis of a system having the actuator, a network of the system, or a cloud.

6. The communication device in accordance with claim 1,
wherein the control device and the actuator communicate over the connection line in accordance with the standard HIPERFACE DSL® or IO-Link.

7. The communication device in accordance with claim 1,
wherein at least one of the first interface and the second interface is configured in accordance with the standard HIPERFACE DSL® or IO-Link.

8. The communication device in accordance with claim 1,
wherein the connection line in the communication device is continued between the first interface and the second interface and transmits signals of the connection line.

9. The communication device in accordance with claim 8,
wherein the connection line transmits the signals of the connection line while amplifying the signals.

10. The communication device in accordance with claim 1,
wherein the communication device has a master/slave unit that is connected to the first interface and to the second interface.

11. The communication device in accordance with claim 10,
wherein the master/slave unit is configured in accordance with the standard HIPERFACE DSL® or IO-Link.

12. The communication device in accordance with claim 1,
that has a communication control that is configured to evaluate the signals transmitted on the connection line between the actuator and the control device and to decide which signals and/or data are output at the first interface, at the second interface, and/or at the third interface.

13. The communication device in accordance with claim 12,
wherein the communication control is configured to filter, sort, and/or pre-process the data that are output to the outside via a third interface.

14. The communication device in accordance with claim 12,
wherein the communication control is configured to compare the signals and/or data with an expectation.

15. The communication device in accordance with claim 12,
wherein the communication control is configured for a protocol adaptation between the first interface and the second interface.

16. The communication device in accordance with claim 15,
wherein the protocol adaptation comprises a change of the resolution and/or data rate.

17. The communication device in accordance with claim 12,
wherein the communication control is configured to at least partially replace the data flow from the actuator and/or control device.

18. The communication device in accordance with claim 12,
wherein the communication control is configured to request additional data from the sensor that the control loop does not require.

19. The communication device in accordance with claim 12,
that has at least one connector for an additional sensor.

20. A method of transferring data from a control loop having a control device and
an actuator that is connected to the control device via a connection line and that has a sensor for determining a control variable,
wherein a communication device is connected via a first interface in the connection line to the control device and via a second interface in the connection line to the actuator; and wherein the communication device transfers at least some of a communication on the connection line or data acquired therefrom via third interface to a third system.

21. The method according to claim 20, wherein the communication device comprises the control device and the actuator that is connected to the control device via the connection line and the sensor for determining a control variable, wherein the communication device has the first interface for connecting to the control line for a connection to the control device, the second interface for a connection to the actuator, and the third interface for a connection to said third system to transfer at least some of a communication on the connection line or data acquired therefrom to the third system.
